(19) United States
(12) Patent Application Publication
(10) Pub. No.: US 2013/0275097 A1
(43) Pub. Date: Oct. 17, 2013

(54) AIR FLOW ESTIMATION

(71) Applicants: Paul Milburn, Nottingham (GB); Stuart Peter Redshaw, Nottingham (GB); Patrick Tindale, Nottingham (GB)

(72) Inventors: Paul Milburn, Nottingham (GB); Stuart Peter Redshaw, Nottingham (GB); Patrick Tindale, Nottingham (GB)

(73) Assignee: 4Energy Limited, Nottingham (GB)

(21) Appl. No.: 13/825,635

(22) PCT Filed: Sep. 20, 2011
(86) PCT No.: PCT/GB11/51762

§ 371 Date: Jun. 28, 2013

(30) Foreign Application Priority Data
Sep. 23, 2010 (GB) 1015963.0
Apr. 15, 2011 (GB) 1106442.5

(51) Int. Cl. G06F 17/50

(52) U.S. Cl. CPC G06F 17/50
USPC 703/2

(57) ABSTRACT

A computerised method for estimating air flow within a ventilated room comprising a plurality of air supply units configured to supply air to a plurality of vents arranged across a floor of the room over an air supply plenum, the method comprising the steps of: i) identifying a vent having a minimum distance to any one of the air supply units; ii) for each of a selected number of the air supply units, calculating a contribution of air flow supplied to the identified vent from a sum of ratios of distances between the identified vent and each of the air supply units; and iii) repeating step ii) for a vent having a next minimum distance to any one of the air supply units until a contribution of air flow for each of the plurality of vents is calculated.

The invention relates to estimating air flow in a ventilated room, particularly a data centre, in which a number of air supply units provide air flow to the room via an under-floor plenum.

Modern data centres typically contain large amounts of electronic equipment for data storage and processing, which require large amounts of electrical power, effectively all of which is transformed into heat. Large data centres may require of the order of several MW of electrical power, resulting in a substantial amount of heat that needs to be transported in some way. A typical setup of such data centres involves racks of individual units of electrical equipment separated by walkways, to allow for equipment in the racks to be accessible for replacement and maintenance of individual units. Cooling of the electrical equipment is commonly achieved through air flow through equipment racks, since other more efficient methods of cooling (such as those based on liquid circulation through heat exchangers) are less practical when equipment needs to be replaced and repaired on a regular basis.

An important feature of any data centre therefore relates to how best to optimise air flow through the electrical equipment to most efficiently remove heat, in order to maintain the temperature of each equipment rack within safe operating parameters. Air flow is typically supplied in a data centre via an under-floor ventilation system supplied by one or more air supply units. Such air supply units may provide air cooled by means of a chiller or may rely on ‘free air’, i.e. external ambient air alone. The air supply may be recirculated in the case of artificially cooled air.

For a data centre based on the above type of layout, where air is supplied via an under-floor plenum, it is therefore important to know, or at least have a good estimate of, how effectively air being supplied is acting to cool equipment in the room. Data on the temperature of each item of electrical equipment may be available for monitoring purposes, and this data can be displayed in a form that allows an assessment to be made of any units that may be either overheating or underutilised.

If changes are made to the layout of a data centre it can be difficult to assess beforehand, particularly if the data centre is large, what effect any changes will have on the overall air flow, and therefore the effect on equipment cooling, for example to determine if any additional cooling capacity would be required and whether the data centre would need to be reconfigured.

One way of assessing the efficiency of cooling in a data centre is through the use of computer modelling, and in particular using known modelling techniques such as computational fluid dynamics (CFD). Such techniques can be used to model the distribution of air flow and temperature throughout a data centre, given inputs based on the layout of the data centre, the expected electrical equipment power usage for each rack and air flow supplied by each air supply unit.

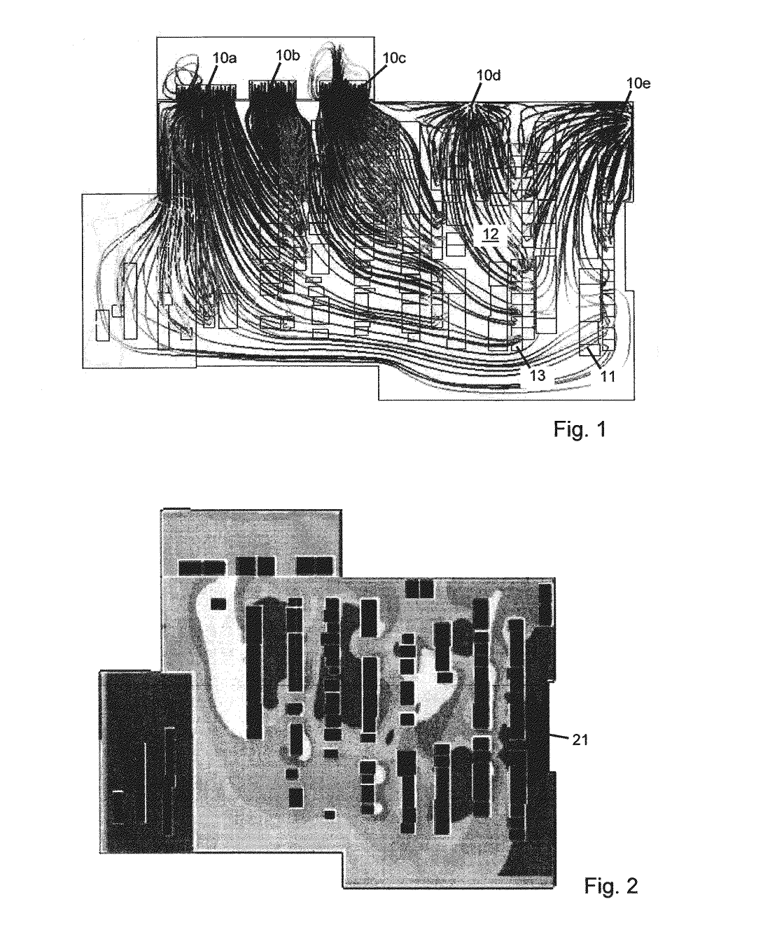

An exemplary form of output from a CFD model is shown in FIG. 1, which illustrates the expected air flow paths and velocity profiles for a data centre supplied with air from five separate air supply units 10a-e. The layout of the data centre comprises various equipment racks 11 laid out across a floor 12 having vents 13 through which air is supplied from the air supply units 10a-e. Air flow velocity is, predictably, highest in regions closer to the air supply units 10a-e, and is lowest in regions furthest away from any air supply units. The effect of air flow on intervening structures in the data centre, for example the number and layout of floor vents for distributing air within the room and any obstructions in the underfloor plenum, is not generally straightforward to predict and therefore requires such computer modelling to arrive at a reasonable estimate.

CFD modelling can also be used to predict a temperature profile across the data centre, an example of which is shown in FIG. 2. Different temperature regions are indicated with lighter and darker shading, with a high temperature reading 21 indicated at a region of the data centre that corresponds to an area that is not receiving sufficient air flow.

Although CFD modelling may provide a good guide in designing a data centre layout and associated air cooling requirements, provided accurate input data is used, a problem with such modelling techniques is their computational intensiveness. Even with high power computers, a full assessment of air flow within a typical data centre using CFD may take several hours to run to completion. This makes any assessment of proposed changes to a layout of any degree very time-consuming and impractical for ongoing use. Since air flow supply units may in practice fail, it is important to ensure that such failures do not result in equipment failure due to overheating. To carry out computer modelling runs for every possible eventuality, however, would involve extensive computer power and time. As a result, air flow cooling systems will tend to be over-specified to ensure that sufficient cooling air is always provided. Any over-specification clearly results in a waste of energy, either in the form of a degree of cooling capacity that is not required or in providing more cooling to some equipment than is required to maintain the equipment within a desired temperature range.

It is an object of the invention to address one or more of the above mentioned problems.

In accordance with a first aspect of the invention there is provided a computerised method for estimating air flow within a ventilated room comprising a plurality of air supply units configured to supply air to a plurality of vents arranged across a floor of the room over an air supply plenum, the method comprising the steps of:
i) identifying a vent having a minimum distance to any one of the air supply units;
ii) for each of a selected number of the air supply units, calculating a contribution of air flow supplied to the identified vent from a sum of ratios of distances between the identified vent and each of the air supply units; and
iii) repeating step ii) for a vent having a next minimum distance to any one of the air supply units until a contribution of air flow for each of the plurality of vents is calculated.

An advantage of the invention is that an estimate of the air flow distribution can be made very quickly compared to existing computationally-intensive methods, but with a sufficient accuracy to be useful in assessing the effect of changing the layout of the room, for example by analysing what effect changing the air supply units or vent layout is likely to have on overall air flow.

The selected number of air supply units for which the contribution to each vent is calculated may be less than or equal to the number of the plurality of air supply units. Taking into account all of the air supply units for each calculation may result in a more representative calculation, but at the expense of a reduction in speed. In some cases, as few as two or three air supply units may be taken into account for each vent, resulting in an increase in speed of calculation.

A volume flow rate through each identified vent may be calculated from a sum of contributions from each air supply unit, which enables measures of mass flow rates, and therefore an assessment of cooling capacity, to be made for each vent.

The contribution of air flow supplied to the identified vent is preferably calculated from an inverse of the sum of ratios of distances. The ratios of distances may be linearly weighted or weighted according to the squares of the distances. The contribution of air flow from a particular air supply unit supplied to the identified vent may be calculated according to the relationship:

$${V}_{f} = {V}_{avg} \frac{1}{{\sum }_{i = 1}^{n} \frac{{d}_{f ↔ x}^{p}}{{d}_{f ↔ i}^{p}}}$$

where V_{f} is the calculated volume flow rate for the vent, V_{avg} is an average flow rate over all of the vents from all of the air supply units, n is the selected number of air supply units, [symbol] is the distance between the vent to the particular air supply unit and [symbol] is the distance between the vent and one of the selected number of air supply units.

In the above relationship, the exponent p may typically be 1 or 2, although other values may be used. A linear weighting is applied with p=1, and a weighting according to the squares of distances is applied with p=2.

An estimated air volume flow rate through each identified vent is preferably calculated from a sum of contributions from each air supply unit to the identified vent.

According to embodiments of the invention, a volume flow rate remaining from each air supply unit is reduced by the calculated contribution for each identified vent prior to repeating step ii). Step ii) may be repeated until the volume flow rate from all of the air supply units reaches zero. Using this iterative method of calculating air flow by determining air flow for those vents closest to the air supply units results in estimated air flows distributions that can more closely match reality.

A proportion of the minimum distances may be calculated from a direct line between each vent and each air supply unit. A proportion of the minimum distances may alternatively or additionally be calculated from a series of connected lines between each vent and each air supply unit via a baffle extending across the underfloor plenum.

As an additional feature, an initial assessment may be made regarding each air supply unit prior to steps ii) and iii) being carried out. This may involve identifying a subset of vents within a distance from each air supply unit that is proportional to the total air flow rate supplied by that unit and assigning a set air flow contribution to each vent in the subset of vents. The subset of vents may be removed from the following iterative process, and the total air flow accounted for by the subset of vents accordingly reduced from each air supply unit. This additional step takes into account the fact that vents closest to the air supply units will tend to be fully supplied with air, and can therefore be taken out of the iterative process.

As a further modification to the above feature, the subset of vents may be identified according to a directionality of air flow from each air supply unit. The directionality of air flow may be determined according to the position of each air supply unit relative to a wall or partition in the room. The directionality may be further modified according to the relative location of each air supply unit. In a particular exemplary embodiment, the subset of vents may include vents covering a vector extending from an air supply unit in a preferred air flow direction for that unit, the length of the vector being proportional to the air flow from that unit. The vector may be rotated within the plane of the under-floor plenum by an amount dependent on a distance between adjacent air flow units. When such vectors are used to determine subsets of vents where vectors from different air supply units cross, an artificial internal partition or baffle may be applied transverse a connecting line between the air supply units. The internal partition ensures that the resulting estimate of air flow more closely matches reality, in situations where air flow paths from adjacent units are likely to combine.

An air flow vector may be assigned to a selected one of the air supply units, the vector having a length and direction according to a rate and direction of air flow from the air supply unit, a distance between each vent and the selected air supply unit being a sum of the vector and a line connecting an end of the vector with the vent.

Any vent within a predefined area surrounding the vector may be assigned an air flow that is determined to be provided solely by the selected air supply unit. This simplifies the calculation process and closely matches a typical scenario where air vents close to air supply units tend to be supplied with practically all of their air by a single supply unit.

In the case where air flow vectors are assigned to two or more air supply units, the orientation of a pair of air flow vectors determined to cross each other may be adjusted to orient the vectors so that they do not cross. This step takes into account that directed air flows from air supply units close to one another tend to interfere and reinforce each other, particularly where the units are facing partly towards one another, for example on adjacent walls near the corner of the ventilated room. In such situations, an artificial baffle may be generated between the pair of adjacent air flow units, the artificial baffle bisecting a line connecting the centres of the pair of air flow units, where the air flow vectors are adjusted so that they do not cross the artificial baffle. Such artificial baffles may be used to more closely match the air flow pattern in the underfloor plenum where air flows from adjacent units interfere.

The method of according to the first aspect of the invention may further comprise comparing a calculated air flow through a subset of the plurality of vents to a predefined air flow for the subset of the plurality of vents. An alarm signal may be output if the calculated air flow differs from the predefined air flow by more than a predefined margin. The subset of the plurality of vents may include vents within a set distance of an equipment rack in the ventilated room. The alarm signal may be output at a remote location where the ventilated room is located.

The method according to the first aspect of the invention may comprise taking a measurement of air flow within the ventilated room to provide a measured value of air flow for the subset of the plurality of vents, wherein the predefined air flow is the measured value of air flow for the subset of the plurality of vents.

The method according to the first aspect of the invention may comprise the step of adjusting operation of equipment in the ventilated room dependent on the calculated air flow for each of the plurality of vents. The step of adjusting operation of equipment optionally comprises one or more of:
adjusting air flow provided by one or more of the plurality of air supply units;
adjusting a direction or amount of air flow through one or more of the plurality of vents;
enabling or disabling an air supply unit;
adjusting a temperature set point of an air supply unit; and
adjusting operation of an equipment rack in the ventilated room.

The method according to the first aspect of the invention, being computerised, is carried out by means of an application residing on a processor of a computer. Data is input to the application regarding the arrangement of the ventilated room and is stored in memory, the data including the relative locations of each of the plurality of air supply units and plurality of vents, and the layout of the room itself, including the arrangement of walls, any internal partitions and the locations of equipment racks. The application processes the data to calculate the contribution of air flow supplied to each vent in an iterative process until each of the plurality of vents has been considered. The calculated contributions are stored in the memory, and an output is provided by the application that indicates the calculated contribution of air flow for each of the plurality of vents, preferably in the form of a graphical representation of the ventilated room, showing the relative air flows through each of the plurality of vents.

In accordance with a second aspect of the invention there is provided a computer program configured to cause a computer to perform the above method. The computer program may be embodied on a computer readable medium such as a storage disc.

In accordance with a third aspect of the invention there is provided a computer system for estimating air flow within a ventilated room comprising a plurality of air supply units configured to supply air to a plurality of vents arranged across a floor of the room over an air supply plenum, the computer system configured to:
i) identify a vent having a minimum distance to any one of the air supply units;
ii) for each of a selected number of the air supply units, calculate a contribution of air flow supplied to the identified vent from a sum of ratios of distances between the identified vent and each of the air supply units; and
iii) repeat step ii) for a vent having a next minimum distance to any one of the air supply units until a contribution of air flow for each of the plurality of vents is calculated.

The computer system may be configured to adjust operation of equipment in the ventilated room dependent on the calculated air flow for each of the plurality of vents, for example by:
adjusting air flow provided by one or more of the plurality of air supply units;
adjusting a direction or amount of air flow through one or more of the plurality of vents;
enabling or disabling an air supply unit;
adjusting a temperature set point of an air supply unit; and/or
adjusting operation of an equipment rack in the ventilated room.

The computer system according to the third aspect of the invention may be further configured to carry out other optional features corresponding to those of the first aspect.

Aspects and embodiments of the invention are described in further detail below by way of example and with reference to the enclosed drawings in which:

FIG. 1 is an exemplary display of calculated output airflow in a data centre based on a CFD computer model;

FIG. 2 is an exemplary display of a temperature profile in a data centre based on a CFD computer model;

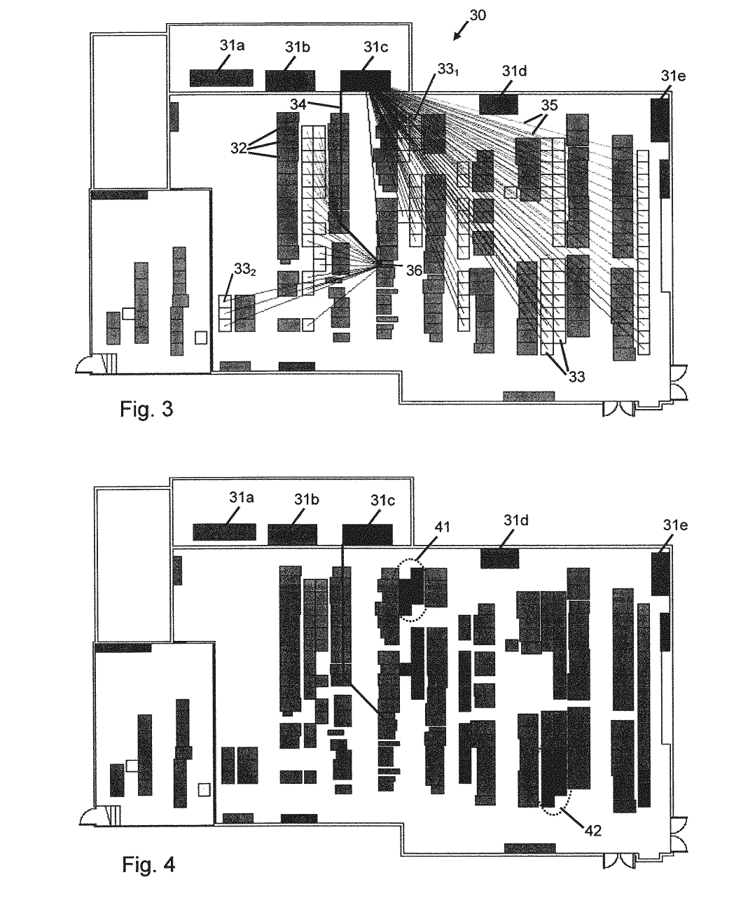

FIG. 3 is a schematic plan view of a data centre, in which linear distances between one of a plurality of air supply units and each of a plurality of floor vents are indicated;

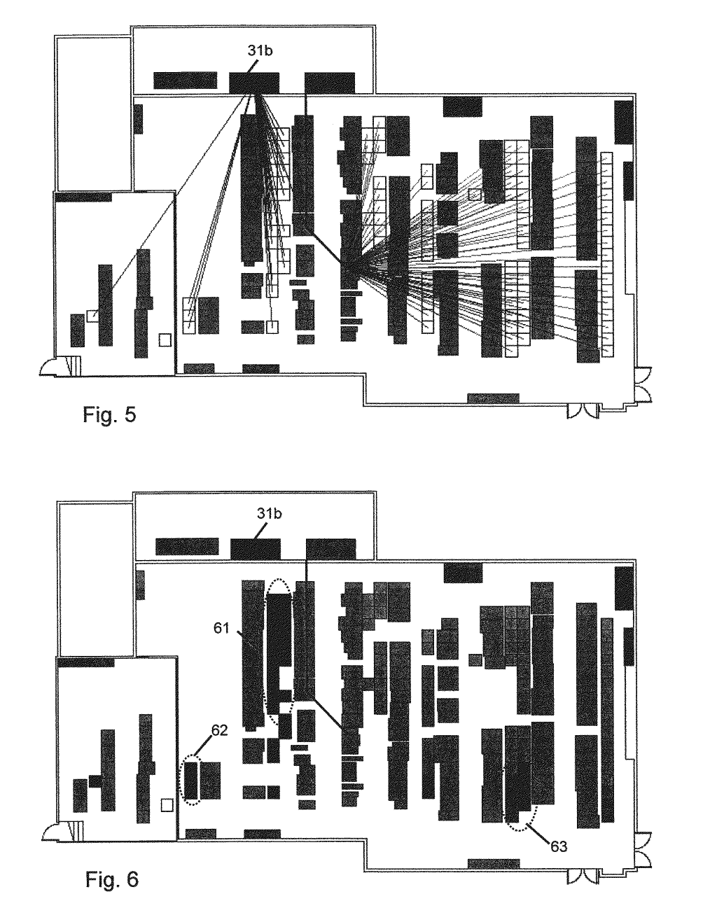

FIG. 4 is a schematic plan view of the data centre of FIG. 3, indicating a resulting pattern of air flow through the plurality of vents derived from one of the air supply units;

FIG. 5 is a schematic plan view of the data centre of FIGS. 3 and 4, in which linear distances between a different one of the plurality of air supply units and each of the plurality of floor vents are indicated;

FIG. 6 is a schematic plan view of the data centre of FIG. 5, indicating a resulting pattern of air flow through the plurality of vents derived from the air supply unit;

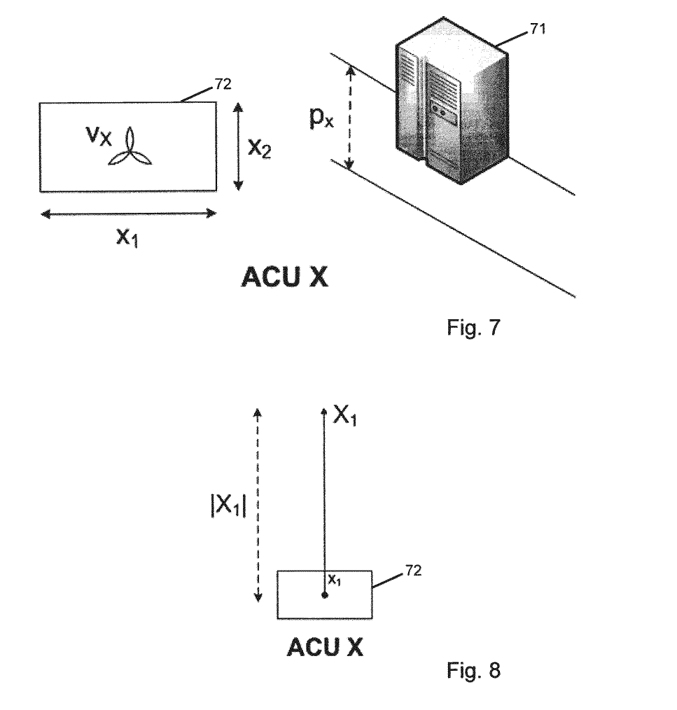

FIG. 7 is a schematic diagram indicating the dimensions and positioning of an air supply unit;

FIG. 8 is a diagram indicating an air flow vector extending from an directed outlet of an air supply unit;

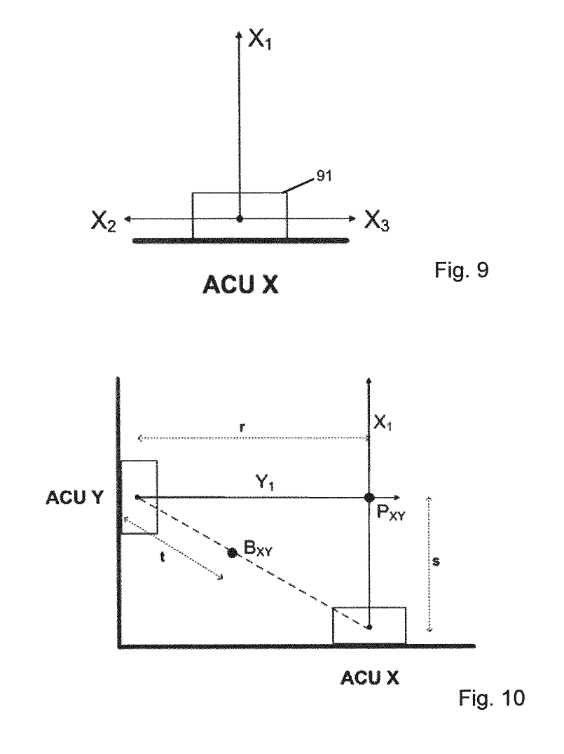

FIG. 9 is a diagram indicating air flow vectors extending from a non-directed outlet of an air supply unit;

FIG. 10 is a diagram indicating two air supply units in close proximity having crossing air flow vectors;

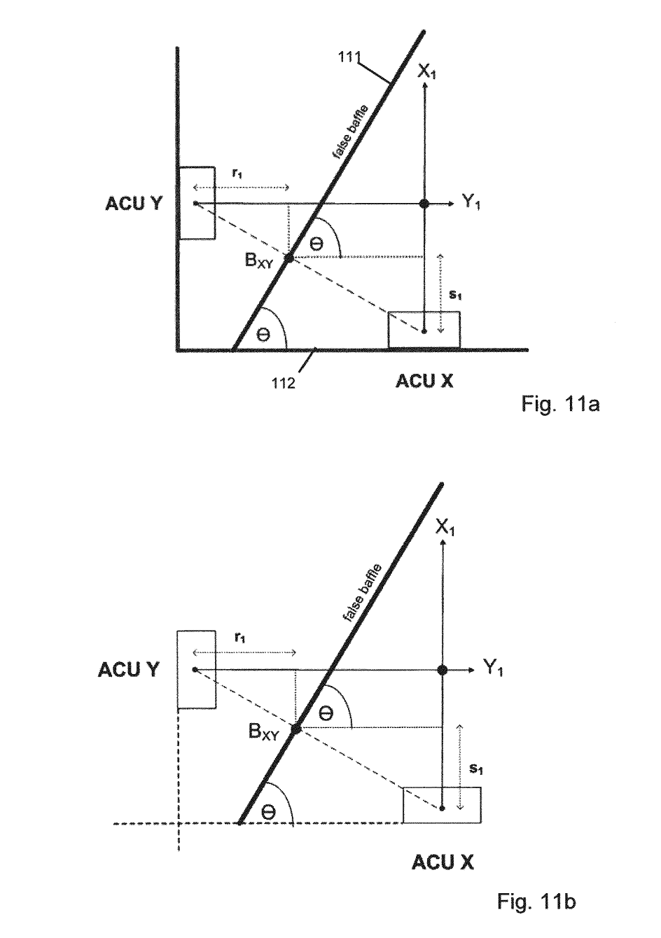

FIG. 11a is a diagram of the air supply units of FIG. 10 with an artificial baffle;

FIG. 11b is a diagram of the air supply units of FIG. 11a with an artificial baffle generated in the absence of walls;

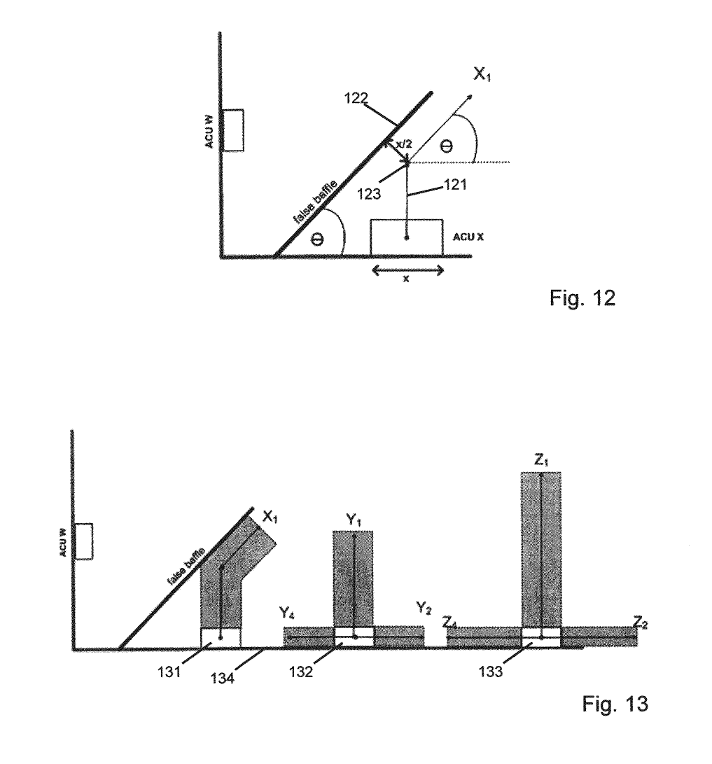

FIG. 12 is a diagram of the air supply units of FIGS. 10 and 11a with an air flow vector adjustment;

FIG. 13 is a diagram of directed and non-directed air supply units with air flow vectors and associated flow paths;

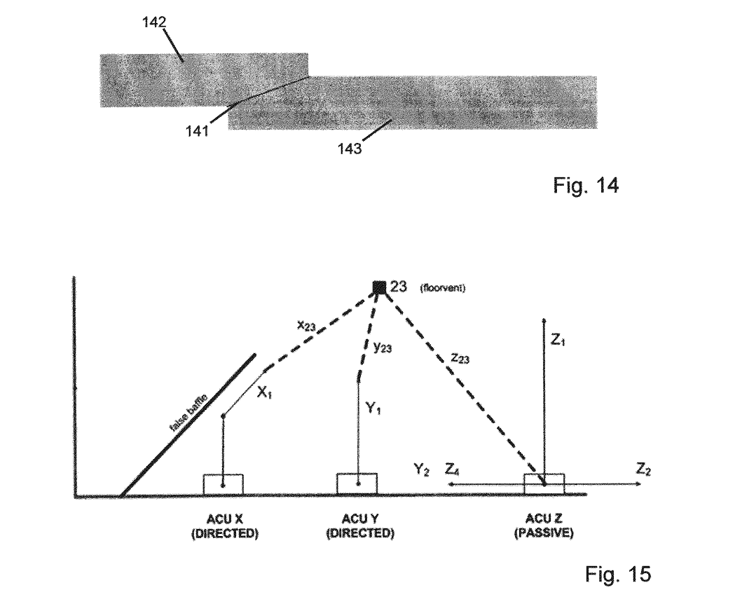

FIG. 14 is a diagram of overlapping flow paths from two air supply units;

FIG. 15 is a diagram indicating calculation of distances from air supply units to a floor vent;

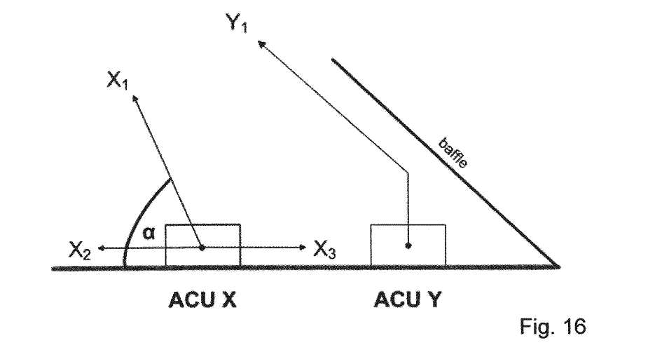

FIG. 16 is a diagram of a pair of air supply units having adjusted air flow vectors;

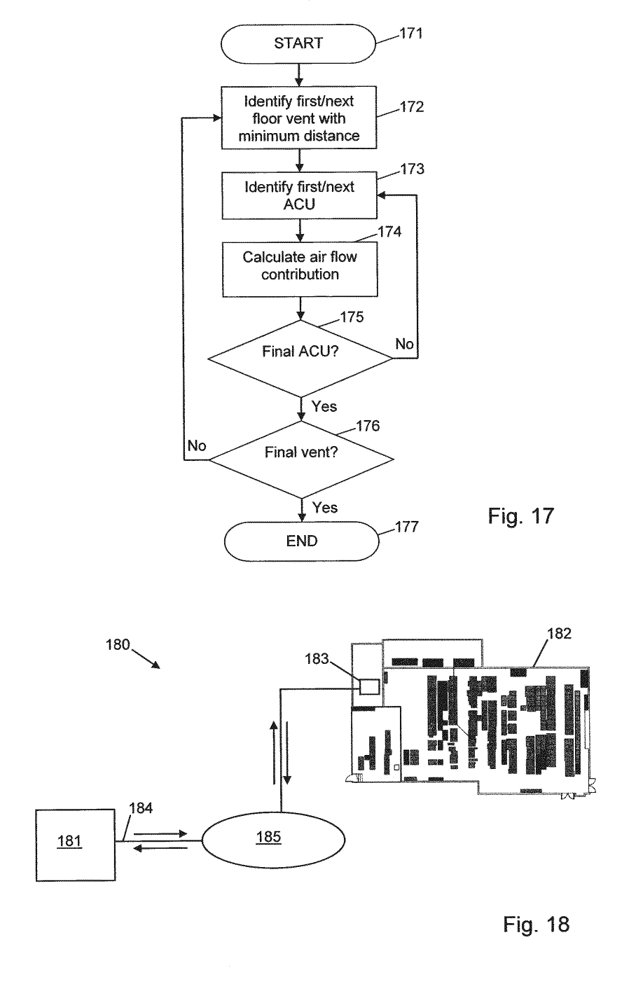

FIG. 17 is a flow diagram illustrating a sequence of method steps according to an embodiment of the invention; and

FIG. 18 is a schematic diagram of an exemplary system for monitoring and controlling air flow in a ventilated room.

FIGS. 1 and 2, showing exemplary outputs from CFD modelling relating to air flow and temperature in a data centre, have already been discussed above in relation to the background to the invention.

FIG. 3 illustrates in plan view a data centre 30 having a similar layout to that shown in FIGS. 1 and 2. The data centre 30 comprises a plurality of air supply units 31a-e, a plurality of equipment racks 32 arranged in rows and a plurality of floor vents 33 arranged across a floor of the data centre. The floor vents 33 are supplied with air from each of the air supply units 31a-e via an underfloor plenum, which extends across the entire room 30. A partition wall or baffle 34 is provided within the under-floor plenum to redirect air flow from the air supply unit 31c towards the right of the partition 34 and away from the vents to the left of the partition that are supplied with air from air supply units 31a, 31b. Each of the items in the data centre layout 30 are preferably drawn to scale, the dimensions being obtained either from a plan of a proposed data centre or from measurements taken on an actual data centre.

Also shown in FIG. 3 are lines 35 that connect air supply unit 31c to each of the floor vents 33. In the case of the vents that are situated to the left hand side of the partition wall 34, the lines are connected around the partition wall or baffle 34 such that the shortest distance between each vent and the air supply unit 31c is indicated. The presence of the partition wall therefore has the effect of adding to the total distance between the air supply unit 31c and each of the vents to the left of the wall 34.

According to an embodiment of the invention, the lengths of the lines connecting the air supply unit 31c to each of the vents 33 are used to calculate an air flow contribution from the air supply unit 31c to each of the vents 33. Taking each vent in turn, starting with the vent closest to the air supply unit 31c, which in this case is vent 33₁, a contribution of air flow from the air supply unit 31c is calculated according to the ratio of distances between the vent and the supply unit. This is because the supply unit that is closest to the vent in question will tend to supply more air than the units further away.

For each floor vent having two dimensional Cartesian co-ordinates Fₓ, F_{y} in relation to each air supply unit having co-ordinates Aₓ, A_{y}, the distance [symbol] between each vent and each unit can be calculated according to the following relationship;

[symbol]

=\sqrt{[(Fₓ−Aₓ)²+(F_{y}−A_{y})²]} (1)

The above relationship gives the shortest distance for each vent and air supply unit. In case there are any obstructions in the under-floor plenum, such as baffles, the distance is calculated from a sum of the distances between points that together make up the shortest route between the air supply unit and the vent. For example, the distance between air supply unit 31c and vent 33₂ is the sum of distances between unit 31c and an end 36 of the baffle 34 and between the end of the baffle 34 and the vent 33₂.

Shown in Table 1 below is an example of an unsorted list of distances calculated for vents relative to each of the air supply units. Provided the floor plan is to scale, the units of measurement for the distances used are not relevant, although would typically be in metres. Each air supply unit (hereinafter referred to as ACU) is identified by a number, ACU5-9.

Arranging the floor vents in distance order, starting from the vent that is closest to any of the air supply units, results in the sorted list shown in Table 2 below. The vents are also sorted according to the next nearest ACUs, in this case the second, third, fourth and fifth nearest units. In Table 2 below, the vent identified as vent number 90, which is 1.414 units away from the vent identified as ACU8, is the closest of all the vents to any ACU. The next closest vent is number 1, which is 3 units away from ACU7, and so on.

TABLE 1
Unsorted matrix of distances between vents and air supply units (ACUx).

| Vent | | | | | | | |
|---|---|---|---|---|---|---|---|
| No. | Fx | FY | ACU5 | ACU6 | ACU7 | ACU8 | ACU9 |
| 1 | 5 | 6 | 12.369 | 6.708 | 3.000 | 45.608 | 38.615 |
| 2 | 8 | 13 | 7.810 | 6.083 | 9.220 | 38.360 | 31.367 |
| 3 | 9 | 13 | 8.602 | 7.071 | 9.899 | 37.670 | 30.677 |
| 4 | 10 | 13 | 9.434 | 8.062 | 10.630 | 37.017 | 30.024 |
| 5 | 11 | 13 | 10.296 | 9.055 | 11.402 | 36.405 | 29.412 |
| 6 | 12 | 13 | 11.180 | 10.050 | 12.207 | 35.842 | 28.849 |
| 7 | 13 | 13 | 12.083 | 11.045 | 13.038 | 35.334 | 28.341 |
| 8 | 14 | 13 | 13.000 | 12.042 | 13.892 | 34.887 | 27.894 |
| . . . | | | | | | | |

TABLE 2
Sorted matrix of vents according to distance to the nearest ACU.

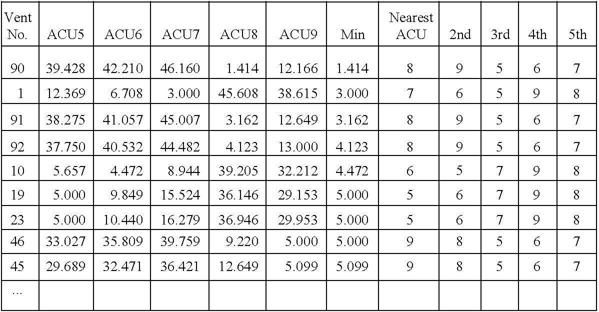

Each of the vents in the sorted list is then attributed an airflow according to the calculations described below.

Firstly, a total air flow from all of the ACUs is determined. This may be derived from a specified air flow for each unit or from actual calculations taken on site. An average volumetric air flow V_{avg} for each floor vent may be obtained by dividing the total volume flows from all ACUs by the total number of vents.

For each floor vent, in the order determined by the sorted matrix (as in Table 2 above), the ratio rₓ of air flow attributed to a specified number of the air supply units (where x indicates a number from 1 to n, n being the number of ACUs under consideration) is calculated according to the distance between the vent and one of the air supply units, [symbol] compared with the total of the distances between the vent and all of the ACUs, for example according to the following relationship:

$${r}_{x} = \frac{1}{{\sum }_{i = 1}^{n} \frac{{d}_{f ↔ x}^{p}}{{d}_{f ↔ i}^{p}}} \qquad ( 2 )$$

The number n of ACUs chosen may be less than or equal to the total number of ACUs available. In the above equation, the exponent p may be chosen according to how the distances are weighted. With p=1, the distances are linearly weighted, and with p=2 a weighting is applied according to the square of the distances. Other exponents may alternatively be applied according to a desired weighting.

The ratio rₓ is then multiplied by the average total volume flow V_{avg} of the vent (as calculated above) to give the amount supplied by that particular ACU. The estimated total amount of air flowing through the vent, V_{f}, is therefore calculated from the sum of contributions from each ACU, i.e.

$${V}_{f} = {\sum }_{i = 1}^{i = n} {V}_{avg} {r}_{i} \qquad ( 3 )$$

The amount of air flow contributed by each ACU is then deducted from the air flow that is available from that unit, and the above process repeats for the next nearest vent in the ordered list. When an amount of air flow for an air supply unit reaches zero, this is taken out of the calculation for the total amount of air flowing through subsequent vents and the next closest ACU is used. The calculation process stops once either all vents have been accounted for or all ACUs have been exhausted. If carried out taking into account all ACUs for each vent, rather than a subset, each ACU should have used up all of the initially attributed air flow by the time the process reaches the calculation for the last vent in the ordered list.

As an example, consider a vent in relation to five air supply units A, B, C, D, and E. If n is chosen to be 3, the above process will calculate the ratios for the three ACUs closest to the vent that are capable of supplying air to the vent. If the ACUs are arranged in order of proximity, with A being closest, ACUs A, B and C are considered for the vent. If, however, one of these ACUs, say B, has already been determined due to previous calculations to have no available air flow left, the process will consider units A, C and D instead.

Once all of the vents in the data centre have been accounted for, the calculated volume air flow information can be displayed as an image to represent airflow trends across the room. Since the above calculations are carried out taking into account the contribution from each individual ACU, the output data can also be presented in the form of the contributions made by each ACU across all of the vents in the room. An example output is shown in FIG. 4, which illustrates the contribution made by ACU 31c to each of the vents in the room. Vents are shaded according to their air flow output contributed by ACU 31c, a darker shading indicating a higher air flow. As may be expected, vents 41 grouped closest to ACU 31c are supplied with more air from that unit. However, what may not be expected is that vents 42 in a group that is considerably further away from ACU 31c also have a high proportion of their air provided by that unit. This is because the other closest supply units 31d, 31e are also taken into account when calculating the proportion of air flow contributed during the above series of calculations.

A further illustration of the distance calculation step is shown in FIG. 5, where the distances from ACU 31b to each of the vents in the room are shown. As for the above example, the contribution of air supplied by each unit is calculated, resulting in an output shown in FIG. 6. As expected, air supply unit 31b contributes most to vents 61 grouped closest to the unit. However, the unit 31b also supplies a substantial proportion to a second group 62 further away from the unit, and a significant proportion to a third group 63 that is far away from the unit. This may be due, for example, to the air supply unit 31b having a substantially higher output compared to other supply units.

Although the above described method uses a much higher degree of generalization than computer modeling employing CFD, the method can be performed in full in an extremely short time as a result of the much simpler series of calculations that are required. In a typical example, carrying out an analysis according to the above method may take a few minutes, compared to around 8 hours to run an equivalent CFD model. The method can therefore be carried out many times in the time that a single comparable CFD calculation is performed, enabling many more alterations to the layout of the room to be made. The technique can therefore be a practical tool in designing and redesigning the layout of a data centre to maximise the efficiency of air cooling in the room and to ensure that each ACU is positioned and operated in the most effective way. The method can also be carried out based on possible failure modes, such as the removal of one or more ACUs, to analyse the effect on air flow within the room and determine to what extent the failure mode would cause a problem.

The method may be employed as part of an online computerised monitoring system for a ventilated room such as a data centre. In such a system, an example of which is illustrated schematically in FIG. 18, the monitoring system 180 may acquire operational data on the data centre 182, the operational data relating to one or more of: the air flow provided by each ACU; the temperature set-point for each ACU; the actual temperature of air provided by each ACU; and the air flow rate through one or more vents in the data centre 182. The air flow rate through one or more vents may be obtained by positioning a selected number of air flow meters on or adjacent a number of vents in the data centre, the measured air flow being provided to the monitoring system. The air flow measured from the meters can be used to validate the modelling process carried out according to the method, and optionally for determining whether the data centre is operating within preferred limits. The monitoring system may be provided at the same location as the data centre 182, i.e. installed on a local computer 183, or alternatively may be provided by a remote computer system 181 at a separate location, the remote computer system 181 connected to receive operational data via a two-way communication link 184, which may be established via the internet 185. The communication link carries operational data regarding the data centre to the remote computer 181 in one direction, while control signals regarding operation of the data centre are carried in the other direction.

In certain embodiments, such as when the methods described herein are used as part of the operation of an online monitoring system for a ventilated room, the method may incorporate features in addition to providing an output indicating a contribution of air flow for each of the plurality of vents in the room. These features may relate to providing outputs that indicate an alarm condition or providing a degree of control over operation of the ventilated room. In both cases, an aim is to improve the efficiency of cooling within the room as a result of the calculations produced by the modelling process.

As a first step following the calculation process, the method may compare a calculated air flow through a subset of the plurality of vents to a predefined air flow for the subset of the plurality of vents. This subset, which may be one or more of the vents in the room, could for example be chosen according to how well they represent the variation in air flow within the room or according to their location in relation to equipment racks in the room that require cooling. As an example, a minimum air flow may be defined for specified vents within the room. As a result of the layout or operation of the room being altered, for example by changing the number or position of vents, equipment racks or ACUs, the calculated air flow across the room will change, and this will be reflected in the output of the modelling process. The output of the method can then compare the air flow at selected locations within the room and provide an alarm signal indicating when, and optionally where, the calculated air flow differs from the predefined air flow by more than a predefined margin. The alarm may be triggered by the calculated air flow falling below the predefined air flow, which would indicate that insufficient air is being provided. Alternatively, the alarm (or a different alarm) may be triggered by the calculated air flow being above a predefined air flow, which would indicate an oversupply of air at the selected locations. A combination of both situations may apply in a single room, for example when excessive air flow is provided in some locations and insufficient air flow in other locations. The alarm, which may be output at the location of the ventilated room or at a remote monitoring station, can be used to indicate how the layout or operation of the room should be changed to address the problem. To allow an operator to more easily view which vents are triggering the alarm signal, the vents calculated to have an air flow differing from the predefined air flow by more than the predefined margin could be indicated on a graphical display of the layout of the room, which may for example be in the form indicated in FIG. 6.

When outputting an alarm signal, the subset of vents may include vents within a set distance of an equipment rack within the room. A calculation may be made of the total air flow provided by the subset of vents compared with a predefined air flow that is determined to be required by the equipment rack. If the equipment rack is not supplied with a sufficient level of air flow, this could trigger the alarm signal. This may be indicated on the graphical display by highlighting the equipment rack(s) in question. An oversupply of air flow to a rack may also be indicated, as this can result in air being supplied that could be diverted elsewhere.

A discrepancy between a calculated air flow and a predefined air flow through a subset of vents within the room may also indicate that a leakage is present in the room, or alternatively that a blockage may be present in the ventilation system. This would be particularly the case where air flow monitors are provided in the room, the output of which can be used to validate the output calculations of the model. While it is not expected that the outputs will be precisely accurate (as with any model), a reasonable bound could be determined for the accuracy of the calculations. If the measured air flow within the room lies outside this bound, i.e. outside a predefined margin around the calculated air flow, this may indicate that air within the room is flowing elsewhere than through the vents. This would indicate to a user that the room should be checked for leaks, blockages or other factors that could affect air flow.

In other embodiments, an output signal may alternatively or additionally be provided for adjusting operation of equipment in the ventilated room, for example by adjusting operation of one or more of the vents in the room, one or more of the air supply units supplying air to the room or one or more of the equipment racks in the room. Such adjustments could be made dependent on a difference between the calculated air flow and a predefined air flow through a subset of the vents. The predefined air flow may be a minimum and/or maximum air flow for a particular vent or group of vents, for example in relation to an equipment rack. The method may enable adjustment of operation of the room automatically, for example by enabling or disabling one or more ACUs when the air flow rate is insufficient or excessive, or may adjust the flow rate or the temperature set-point through one or more of the ACUs. Lowering the temperature set-point of an individual ACU will tend to increase the cooling load of the ACU, and could therefore be used as a (possibly temporary) solution to insufficient cooling being provided in a portion of the room. Increasing the air flow rate from one or more ACUs could also be used to resolve a low air flow issue with a subset of vents within the room. An alternative solution would be to control the distribution of air flow across the room, rather than the total amount of air being provided. To this end, the amount or direction of air flow through a subset of the vents may be adjusted. As an example, if the result of the modelling process is that one part of the room is over-supplied with air, while another part of the room is under-supplied, vents in the over-supplied part may be closed or have their flow rate restricted while vents in the under-supplied part may be opened more fully. A further alternative may be to control operation of one or more equipment racks in the room. If, for example, insufficient air is being provided in a particular location, and no further adjustment is possible to improve this, as a last resort a selected number of items of equipment in the room may be powered down to avoid overheating. Such operations may be remotely controlled, for example by means of motorised louvre assemblies provided in a selected number of vents. The direction of air flow through a selected number of vents may alternatively be changed, for example by altering the angle of a louvred vent to direct air. The direction of air flow may also be altered by rotating a vent having a preferred direction of air flow, for example to direct air flow towards a different equipment rack that is determined to be receiving insufficient air flow.

In a general aspect therefore, the method according to the invention may comprise the step of adjusting operation of equipment within the ventilated room. The equipment may be one or more of the plurality of air supply units, one or more of the plurality of vents or one or more of the equipment racks in the ventilated room, the adjustment being made dependent on the calculated air flow for each of the plurality of vents. The adjustment may be carried out automatically, and may be performed remotely by control of the operation of the air supply units or the directionality or restriction of air flow through the vents. The adjustments may be made by sending control signals over a network connecting the equipment in the ventilated room with a computer system carrying out the method of estimating air flow. The equipment may for example be connected to the network over wired or wireless ethernet connections, and control signals sent (and operational data received) using a communications protocol such as TCP/IP.

An exemplary series of steps is described below in relation to a typical data centre to which the invention can be applied, which includes further features that can be used to refine the calculation process.

As a first step, the dimensions and characteristics of a data centre are input, for example provided from a survey carried out on an actual data centre or from a design of an envisaged data centre. The variables required include:
A measurement of the room (or rooms) and all relevant elements, including:
   i. the length and width of the room;
   ii. the depth of the underfloor plenum;
   iii. the relative position of all ACUs;
   iv. the dimensions of each of the ACU outlets;
   v. the relative position of all floorvents; and
   vi. the permeability of each floorvents, for example in terms of the percentage of open area relative to the total area of the floorvent;
Any underfloor baffles or significant obstructions in the plenum, together with their dimensions.

The above variables are then used to generate a scale plan of the room, for example in the form of a dxf (drawing interchange format) file, which is then loaded into software that is configured to perform the required calculations.

The characteristics of each ACU, which may differ, are also input, including:
airflow and derived volumetric flow rate for each ACU;
the type of ACU identified, which may be either directed or non-directed;
the efficiency of each ACU, to take into account any air leakages or air recirculation.

As a second step, air flow vectors are calculated for each ACU in the room, which depend on the airflow and type of ACU. These air flow vectors represent the directional nature of the ACUs, and are used to alter the subsequent distance calculations to each floor vent to take this directionality into account, to improve the accuracy of the resulting air flow estimation. FIG. 7 illustrates an exemplary ACU 71 having an outlet positioned a distance pₓ above the base of an underfloor plenum, the outlet 72 of the ACU 71 having linear dimensions x₁, x₂ and having an average airflow output speed vₓ. From these variables, and using an efficiency constant eₓ (which may be 1 or smaller), an average volumetric flow rate Fₓ can be calculated:

F_{X}=x₁x₂v_{X}e_{X} (4)

For a directed ACU, i.e. one where the outlet is configured to direct airflow in a specific direction, typically orthogonally to the wall against which the ACU is positioned, the length of the air flow vector is calculated by determining which face the airflow is being directed from (for example the face indicated by x₁ in FIG. 7) and calculating the average velocity of airflow vₓ₁ from this face, as:

$${v}_{{X}_{1}} = \frac{{F}_{X}}{{x}_{1} {p}_{X}} \qquad ( 5 )$$

The length |X₁| of the air flow vector is calculated as:

|X₁|=m_{d}F_{X}+c_{d} (6)

where m_{d} and c_{d} are constants determined based on the dimensions of the room.

The result of the above calculations is that each directed ACU will then be provided with a air flow vector X₁ having a length |X₁| and a direction orthogonal to the wall of the room against which the ACU is positioned, which represents directed airflow from the ACU into the underfloor plenum, as illustrated in FIG. 8.

For non-directed, or passive, ACUs, where air flow can be assumed to flow in all directions away from the outlet 72, air flow vectors can be calculated for each free edge of the ACU outlet, i.e. an edge that is not blocked or positioned near a wall. Whether an outlet is near a wall may be defined according to a minimum distance, as calculated from the centre of the ACU outlet. A typical minimum distance for the purposes of defining whether an outlet is blocked is 2 metres.

For each free edge xₙ, the length of the relevant air flow vector is calculated by first calculating the average volumetric flow F_{X}_{ₙ} from each side xₙ of the outlet, as:

$${F}_{{X}_{n}} = {F}_{X} ( \frac{{x}_{n}}{{\sum }_{i = 1}^{4} {x}_{i}} ) \qquad ( 7 )$$

where xᵢε{all sides for ACU X that are not blocked, according to the above definition}.

Next, the average velocity v_{X}_{ₙ} of airflow from each side xₙ is calculated, as:

$${v}_{{X}_{n}} = \frac{{F}_{{X}_{n}}}{{x}_{n} {p}_{X}} \qquad ( 8 )$$

The length |Xₙ| of each air flow vector is then calculated as:

|Xₙ|=mₚF_{X}_{ₙ}+cₚ (9)

where mₚ and cₚ are constants which are determined based on the dimensions of the room.

As an example, illustrated in FIG. 9, the outlet 91 of a passive ACU is provided with air flow vectors X₁, X₂, X₃, where in this case |X₂|=|X₃|.

Each air flow vector can be considered as a function whose value at any point along the line of the vector (relative to the origin located at the centre of the ACU) can be given by the following formula:

$${ϕ}_{{X}_{n}} ( x ) = ( \frac{{V}_{av} - {v}_{{X}_{n}}}{\vert {X}_{n} \vert} ) x + {v}_{{X}_{n}} for 0 \leq x \leq \vert {X}_{n} \vert \qquad ( 10 )$$

where Vₐᵥ is the average airflow (in m/s) through all floor vents in the room, which is calculated as follows:

$${V}_{av} = \frac{{e}_{R} {\sum }_{i = 1}^{n} {F}_{i}}{{mAe}_{F}} \qquad ( 11 )$$

where n is the number of ACUs, m the number of floor vents, A the area of a floor vent, e_{F} the percentage of the floor vent defined as being open and e_{R} the efficiency of airflow within the room, representing a leakage factor.

In certain embodiments, a further step of implementing artificial baffles may be included, in situations where there exist ACUs for which air flow vectors have been determined to cross each other. This indicates that in practice the air flow streams from these ACUs will interfere with each other. An artificial baffle placed between the ACUs can then be used to change the effective airflow path to each floor vent from these ACUs, making the calculation of airflow more representative. In the case of where more than two vectors cross each other, the two ACUs which are closest to each other are taken into account when determining an artificial baffle.

The artificial baffle is then generated by determining the distance between the two ACUs having crossing air flow vectors using Pythagoras' theorem, i.e. the distance from ACU X to ACU Y being given by \sqrt{r²+s²}, where r and s are the relative orthogonal distances between the ACUs in the plane of the underfloor plenum. Functions φ_{X}_{₁} and φ_{Y}_{₁} given by equation 10 above are then calculated at point P_{XY} where the air flow vectors cross, indicated in FIG. 10. For example, if P_{XY} is 3 metres from ACU X and is 4 metres from ACU Y, the functions are calculated as:

φ_{X}_{₁}(3) (12)

φ_{Y}_{₁}(4) (13)

The position of point B_{XY} is then calculated as a distance t along a direct path from the centre-point of ACU Y to the centre-point of ACU X, as:

$$t = \frac{{ϕ}_{{Y}_{1}} ( r )}{{ϕ}_{{X}_{1}} ( s ) + {ϕ}_{{Y}_{1}} ( r )} \times \sqrt{{r}^{2} + {s}^{2}} \qquad ( 14 )$$

A false baffle 111, shown in FIG. 11, can then be drawn at an angle ø to the horizontal from point B_{XY}, calculated as:

$$φ = {tan}^{- 1} ( \frac{{ϕ}_{{X}_{1}} ( {s}_{1} )}{{ϕ}_{{Y}_{1}} ( {r}_{1} )} ) \qquad ( 15 )$$

where r₁ is the distance along the air flow vector from the centre-point of ACU Y to the point on the air flow vector that would form a perpendicular line if drawn from that point to B_{XY}, and similarly for s₁ and ACU X.

The false baffle 111 will, by definition, intersect the wall 112 at the angle ø, and, passing through B_{XY}, will extend with a length |B_{XY}| calculated as:

|B_{XY}|=a(r+s) (16)

where a is a constant, which may be 1.

For cases where there is no wall to intersect that is in line with either ACU, then the artificial baffle can be determined to extend in a line perpendicularly bisecting a line connecting the two ACUs. This is illustrated in FIG. 11a, in which a false baffle is applied along a line that perpendicularly bisects a line connecting the centres of ACUs X and Y.

Once any artificial baffles are determined, the angle of the air flow vectors from the ACUs can be adjusted to take into account the change of air flow direction that would occur in practice when two ACUs are positioned close to each other. Air flow vectors that cross any baffles, whether real or artificial, can be recalculated according to certain rules. As an example, illustrated in FIG. 12, an air flow vector may be rotated by an angle ø of intersection between the vector 121 and baffle 122 about a point 123 a set distance away from the baffle 122. The distance may be related to the dimension of the ACU opening. In FIG. 12, this distance is ^{x}/₂, where the width of the ACU opening from which the air flow vector 121 extends is x. The air flow vector 121 therefore continues in a direction parallel to the baffle 122. The length of the vector 121 should remain constant. The direction of any adjustment to an air flow vector will always be in the direction for which the distance from the baffle to the ACU increases as the adjusted angle increases.

In a general aspect, any air flow vector that is determined to cross a baffle, whether real or artificially generated, is adjusted so that a portion of the air flow vector is rotated away from the baffle. The length of the air flow vector preferably remains constant after the adjustment step.

Once the directions and lengths of the air flow vectors for each ACU have been established, in a further step the floor area around each vector can be tessellated, i.e. provided with segments having defined widths either side of each vector that are determined to be uniquely supplied with the airflow from a respective ACU. This step is illustrated in FIG. 13, where three ACU outlets 131, 132, 133 having different airflow paths and directivities are indicated. The air flow vectors for each ACU are each provided with a simple tessellation, which effectively broadens each vector to the width of the relevant ACU outlet dimension from where the vector is determined. For passive ACUs 132, 133, the air flow vectors Y₁, Z₁ directed away from the wall 134 are broadened wider than the air flow vectors Y₂, Y₄, Z₂, Z₄ running parallel to the wall 134.

In cases where tessellations overlap, as illustrated schematically in FIG. 14, a midway point 141 may be drawn between two regions 142, 143 containing air flow vectors from respective ACUs, dividing the region into areas to be supplied with air from each ACU.

Following all of the above steps, the distance from each floor vent to each ACU within the room is then calculated, as outlined above and illustrated schematically in FIG. 15. If an ACU is classed as being directed (as with ACUs X and Y in FIG. 15), the distance between the ACU and each floor vent 23 is calculated as a sum of the distance from the endpoint of the air flow vector to the floor vent 23 and the length of the air flow vector. For the illustrated example, the distance |X₁| from ACU X to floor vent 23 is calculated as:

|X₁|+x₂₃ (17)

If the ACU is passive, or non-directed, as in ACU Z in FIG. 15, the distance to floor vent 23 is instead calculated directly from the centrepoint of the ACU to the centrepoint of the floorvent 23.

If a direct line between an ACU, or an endpoint of a air flow vector in the case of a directed ACU, and a floor vent is obstructed by a baffle, whether real or artificial, then the endpoint of the baffle is used as a ‘mid-way’ point and the calculation is split into two parts which are added together to find the total distance.

Where Qₓ is the x-axis centre point co-ordinate of a floor vent, Q_{y} the y-axis centre point co-ordinate of the floorvent, Cₓ the x-axis centre point co-ordinate of a passive ACU (or the endpoint of an air flow vector for a directed ACU), C_{y} is the y-axis centre point co-ordinate of a passive ACU (or the endpoint of a air flow vector for a directed ACU), the distance d is given by d=√[(Qₓ−Cₓ)²+(Q_{y}−C_{y})²].

The distances for each floor vent are then entered into a distance matrix, an example of which is provided in Table 3 below.

TABLE 3
Unsorted matrix of distances between ACUs and floor vents/tiles.

| FLOOR | Distance | | | | | TESSELLATED |
|---|---|---|---|---|---|---|
| TILE | ACU5 | ACU6 | ACU7 | ACU8 | ACU9 | AREA |
| 1 | 12.369 | 6.708 | 3.000 | 45.608 | 38.615 | ACU 7 |
| 2 | 7.810 | 6.083 | 9.220 | 38.360 | 31.367 | No |
| 3 | 9.602 | 10.071 | 9.899 | 37.670 | 30.677 | No |
| 4 | 9.434 | 8.062 | 10.630 | 37.017 | 30.024 | ACU 6 |
| 5 | 10.296 | 9.055 | 11.402 | 36.405 | 29.412 | No |
| 6 | 11.180 | 10.050 | 12.207 | 35.842 | 28.849 | ACU 6 |
| 7 | 16.083 | 14.545 | 14.038 | 35.334 | 28.341 | No |
| 8 | 13.000 | 15.042 | 14.892 | 34.887 | 27.894 | No |
| . . . | | | | | | |

Each floor vent is then referenced to determine if it lies within one of the tessellated areas as defined in the preceding step outlined above, indicated in Table 3. The above matrix is then effectively split into two tables and sorted into a first list for floor vents which lie within a tesselated area (Table 4 below) and those which lie outside a tesselated area (Table 5 below). Each of these lists is sorted according to the shortest distance to any of the ACUs.

TABLE 4
Floor vents with origins within a tesselated area sorted by shortest
distance to an ACU.

| | | | | | | ACU |
|---|---|---|---|---|---|---|
| FLOOR | Distance | | | | | TESSELLATED |
| TILE | ACU5 | ACU6 | ACU7 | ACU8 | ACU9 | AREA |
| 4 | 9.434 | 8.062 | 10.630 | 37.017 | 30.024 | ACU 6 |
| 6 | 11.180 | 10.050 | 12.207 | 35.842 | 28.849 | ACU 6 |
| 1 | 12.369 | 6.708 | 3.000 | 45.608 | 38.615 | ACU 7 |
| . . . | | | | | | |

TABLE 5
Floor vents with origins not in a tesselated area sorted by shortest distance to an ACU.

| FLOOR | Distance | | | | | MINIMUM | Order of ACU proximity | | |
|---|---|---|---|---|---|---|---|---|---|
| TILE | ACU5 | ACU6 | ACU7 | ACU8 | ACU9 | DISTANCE | 1st | 2nd | 3rd |
| 2 | 7.810 | 6.083 | 9.220 | 38.360 | 31.367 | 6.083 | ACU6 | ACU5 | ACU7 |
| 5 | 10.296 | 9.055 | 11.402 | 36.405 | 29.412 | 9.055 | ACU6 | ACU5 | ACU7 |
| 3 | 9.602 | 10.071 | 9.899 | 37.670 | 30.677 | 9.602 | ACU5 | ACU7 | ACU6 |
| 8 | 13.000 | 15.042 | 13.892 | 34.887 | 27.894 | 13.000 | ACU5 | ACU7 | ACU6 |
| 7 | 16.083 | 14.545 | 14.038 | 35.334 | 28.341 | 14.038 | ACU7 | ACU6 | ACU5 |
| . . . | | | | | | | | | |

The results in Table 5 may be extended to show the order of ACU proximity up to the ⁿ/₂^{th} degree or to the 5^{th} degree, whichever is the greater.

In a further step, the airflow through any floor vents that lie within the tessellated regions as defined in the previous step outlines above is distributed accordingly. These regions have been designated as those that are supplied with air by a single ACU and are likely to have the strongest resultant airflows.

First, the average airflow through all floor vents, Vₐᵥ, is brought forward from the previous calculations and redefined as a first iteration V_{av(iteration 1)}:

$${V}_{av} = \frac{{e}_{R} {\sum }_{i = 1}^{n} {F}_{i}}{{mAe}_{F}} = {V}_{{av}_{( iteration 1 )}} \qquad ( 18 )$$

where n=number of ACUs, m the number of floor vents, A the area of a floor vent, e_{F} the percentage of floor vent defined as being ‘open’ and e_{R} the efficiency of airflow within room, representing a leakage factor.

For each floor vent, in the order determined by the sorted matrix indicated in Table 4 above, the airflow V through each floor vent is calculated:

V_{f}_{ₖ}=max{e_{R}φ_{X}_{ₙ}(x),Vₐᵥ_{_{(iteration k)}}} for 0≦x≦|Xₙ| (19)

From V_{f}_{₁} the volumetric flow F_{f}_{₁} can be calculated for floor vent f₁ as follows:

F_{f}_{₁}=V_{f}_{₁}Ae_{F} (20)

F_{f}_{₁} is then deducted from the total volumetric flow supplied by the ACU multiplied by the efficiency of airflow within the room, e_{R}, which supplies the tessellated region. The average airflow (in m/s) through all remaining floor vents is then recalculated and the process repeats until all floor vents within tessellated regions have been accounted for, i.e.:

$${V}_{{av}_{( iteration k + 1 )}} = \frac{{e}_{R} \{ ( {\sum }_{i = 1}^{n} {F}_{i} ) - ( {\sum }_{i = 1}^{k} {F}_{{f}_{k}} ) \}}{( m - k ) {Ae}_{F}} \qquad ( 21 )$$

where k is the number of floor vents that have passed through the calculation process.

If, during the process of calculating flow rates, a floor vent is reached which the ACU has no more volumetric flow to supply to it, then this floor vent is moved into the other matrix represented by Table 5 above to go through the remaining part of the process, described below.

Each remaining floor vent is attributed the average airflow Vₐᵥ_{_{(iteration k+1)}} remaining after the above step has been completed (where k is the number of floor vents that went through the 1^{st} part of the algorithm). This implies each remaining floor vent has the following volumetric flow:

F_{f}=Vₐᵥ_{_{(iteration k+1)}}Ae_{F} (22)

For each floor vent, in the order determined by the sorted matrix indicated in Table 5, a calculation is performed for the specified number of n ACUs that are nearest to the floor vent to determine the ratio of airflow supplied by each ACU to the floor vent based on the shortest distance. In the case where the nearest two ACUs to a floor vent are considered, these ratios can be calculated according to the following:

$$\begin{matrix}{r}_{{x}_{A}} = \frac{( {x}^{2} + {y}^{2} ) - {x}^{2}}{( {x}^{2} + {y}^{2} )} = \frac{{y}^{2}}{( {x}^{2} + {y}^{2} )} & ( 23 ) \\ {r}_{{y}_{A}} = \frac{{x}^{2}}{( {x}^{2} + {y}^{2} )} 1 - {r}_{xA} & ( 24 )\end{matrix}$$

where rₓ_{_{A}} is the ratio of airflow attributed to ACU X for floor vent A, r_{y}_{_{A}} is the ratio of airflow attributed to ACU Y for floor vent A, x is the distance from floor vent A to ACU X (i.e. the nearest ACU with volumetric flow remaining), and y is the distance from floor vent A to ACU Y (2^{nd} nearest ACU with volumetric flow remaining).

The above equations provide the same result as in equation 2 above when the squares of distances are used (i.e. p=2) and where n=2. To take into account more than two ACUs in each calculation step, equation 2 can be used with a different value for n.

As an optional feature, if one of the ratios exceeds a preset threshold, for example 0.75, the ratio may instead be set to equal 1, and the other ratio (or ratios) set to 0.

Once the ratios are calculated, each ratio is multiplied by the total volume flow of the specified floor vent (as calculated above) to give the amount supplied by each ACU to the floor vent. For the above mentioned case including two nearest ACUs, the volumetric flow rate through vent A contributed by ACUs X and Y is given by:

V_{A}_{_{X}}=F_{f}rₓ_{_{A}} (26)

V_{A}_{_{y}}=F_{f}r_{y}_{_{A}} (27)

where V_{A}_{_{X}} is the volumetric flow of floor vent A apportioned to ACU X, and V_{A}_{_{Y}} the volumetric flow of floor vent A apportioned to ACU Y. These figures are then deducted from the total volume flow of the ACUs in question before the process repeats. When the volume flow of an ACU reaches zero during the above process, then the next closest ACU will be referenced instead.

As an illustrative example of the above process, the closest ACUs to floor vent 99 in order are A, B, C, D, E and F. For n=2, the process will calculate the ratios for ACUs A and B. B, however, has no volume flow available due to previous calculations. The process therefore compensates by taking airflows from A and C instead.

If, once both parts of the above process have been complete, any ACU has any volumetric flow left that is yet to be distributed, the volumetric flow is distributed to all the floor vents it provides in proportion to the ratio with which it supplies each floor vent. As an example, if ACU X has 6.5 cubic metres per second of air still to distribute, this is distributed to the various floor vents according to Table 6 below.

TABLE 6
distribution of remaining air flow among floor vents.

| | | DISTRIBUTION |
|---|---|---|
| FLOOR | | (cubic |
| TILE | RATIO | metres/sec) |
| 1 | 100% | 1.0 |
| 2 | 100% | 1.0 |
| 3 | 50% | 0.5 |
| 4 | 50% | 0.5 |
| 5 | 100% | 1.0 |
| 6 | 100% | 1.0 |
| 7 | 100% | 1.0 |
| 8 | 50% | 0.5 |
| TOTAL | | 6.5 |

An advantage of the above process is that the whole calculation process, once a survey or design is completed for a given data centre, can be performed automatically and very quickly using a standard desktop computer. Instead of a period of hours typically taken to perform a full analysis using computational fluid dynamics (CFD), the calculations can be performed in at most a few minutes, depending on the size and complexity of the data centre being modelled. This allows the design to be changed and the calculations repeated, for example during a process of design and optimisation of cooling efficiency.

The calculations from the process can be readily presented as graphical representations on a computer screen, for example as shown in FIG. 4. Air flow through the different floor vents can be represented as different colours or as degrees of shading, to provide a straightforward indication of the proportion of air being supplied by each ACU. Other indications may also be provided, such as the relative proportion of airflow provided by each ACU.

Further uses of the air flow estimation process according to the invention may include estimations of air pressure, in which the air flow vectors and their relative positions to each other are used to estimate where areas of higher pressure are more likely to occur.

This can be used to adjust the calculations of volumetric flows for floor vents at these points.

“Push factors” may also be used, in which each ACU is considered to have 4 directions of effect and the push factor for each direction can be calculated by considering the volumetric flow and direction of each of the air flow vectors originating from the ACU. This is illustrated schematically in FIG. 16, in which an air flow vector X₁ from ACU X is adjusted by being rotated away from an air flow vector Y₁ from ACU Y that has itself been adjusted to flow along a baffle (which may be either artificial or actual). For each ACU in turn, the direction of the air flow vectors can be adjusted with reference to push factors of adjacent ACUs.

The tesselated areas, indicated in FIG. 13, may be adjusted to be shaped other than rectangular to take into account the distribution of air from an ACU. For example, the shape of a tessellated area around an air flow vector could be adjusted to be in the form of an isosceles trapezoid to better reflect the initial movement of air as it leaves the ACU.

A flow chart illustrating an exemplary embodiment of a method according to the invention is shown in FIG. 17. The method starts at step 171, following which at step 172 the next/first vent is identified having a minimum distance to any of the air supply units. For this vent, at step 173 the next/first ACU in order of distance to the vent is selected and at step 174 the air flow contribution from that ACU is calculated. If the contribution from any further ACUs are to be included, at step 175 the method returns to step 173 and repeats the calculation for the next ACU. Once the contribution for the final ACU is calculated, at step 176 the method either repeats steps 172-175 for any remaining vents or ends at step 177.

Other embodiments are intentionally within the scope of the invention as defined by the appended claims.

1. A computerised method for estimating air flow within a ventilated room comprising a plurality of air supply units configured to supply air to a plurality of vents arranged across a floor of the room over an air supply plenum, the method comprising the steps of:
i) identifying a vent having a minimum distance to any one of the air supply units;
ii) for each of a selected number of the air supply units, calculating a contribution of air flow supplied to the identified vent from a sum of ratios of distances between the identified vent and each of the air supply units; and
iii) repeating step ii) for a vent having a next minimum distance to any one of the air supply units until a contribution of air flow for each of the plurality of vents is calculated.

2. (canceled)

3. The method of claim 1 wherein the contribution of air flow supplied to the identified vent is calculated from an inverse of the sum of ratios of distances.

4. The method of claim 3 wherein the ratios of distances are linearly weighted.

5. The method of claim 3 wherein the ratios of distances are weighted according to the squares of the distances.

6. The method of claim 3 wherein the contribution of air flow from a particular air supply unit supplied to the identified vent is calculated according to the relationship
$${V}_{f} = {V}_{avg} \frac{1}{{\sum }_{i = 1}^{n} \frac{{d}_{f ↔ x}^{p}}{{d}_{f ↔ i}^{p}}}$$
where V_{f} is the calculated volume flow rate for the vent, V_{avg} is an average flow rate over all of the vents from all of the air supply units, n is the selected number of air supply units, [symbol] is the distance between the vent to the particular air supply unit and [symbol] is the distance between the vent and one of the selected number of air supply units.

7. (canceled)

8. (canceled)

9. The method of claim 1 wherein an estimated air volume flow rate through each identified vent is calculated from a sum of contributions from each air supply unit to the identified vent.

10. The method of claim 9 wherein a volume flow rate remaining from each air supply unit is reduced by the calculated contribution for each identified vent prior to repeating step ii).

11. The method of claim 10 wherein step ii) is repeated until the volume flow rate from all of the air supply units reaches zero, the air flow for any vents remaining unidentified being determined to be zero.

12. (canceled)

13. The method of claim 1 wherein a proportion of the minimum distances are calculated from a series of connected lines between each vent and each air supply unit via a baffle extending across the underfloor plenum.

14. The method of claim 1 wherein an air flow vector is assigned to a selected one of the air supply units, the vector having a length and direction according to a rate and direction of air flow from the air supply unit, a distance between each vent and the selected air supply unit being a sum of the vector and a line connecting an end of the vector with the vent.

15. The method of claim 14 wherein any vent within a predefined area surrounding the vector is assigned an air flow solely from the selected air supply unit.

16. The method of claim 14 wherein air flow vectors are assigned to two or more air supply units and the orientation of a pair of crossing air flow vectors from adjacent air flow units is adjusted to orient the air flow vectors so that they do not cross.

17. The method of claim 16 wherein an artificial baffle is generated between the pair of adjacent air flow units, the artificial baffle bisecting a line connecting the centres of the pair of air flow units, the air flow vectors adjusted so they do not cross the artificial baffle.

18. The method of claim 1 comprising:
comparing a calculated air flow through a subset of the plurality of vents to a predefined air flow for the subset of the plurality of vents.

19. The method of claim 18 further comprising the step of:
outputting an alarm signal if the calculated air flow differs from the predefined air flow by more than a predefined margin.

20. (canceled)

21. (canceled)

22. The method of claim 19 comprising:
taking a measurement of air flow within the ventilated room to provide a measured value of air flow for the subset of the plurality of vents,
wherein the predefined air flow is the measured value of air flow for the subset of the plurality of vents.

23. The method of claim 1 comprising the step of adjusting operation of equipment in the ventilated room dependent on the calculated air flow for each of the plurality of vents.

24. The method of claim 23 wherein the step of adjusting operation of equipment comprises one or more of:
adjusting air flow provided by one or more of the plurality of air supply units;
adjusting a direction or amount of air flow through one or more of the plurality of vents;
enabling or disabling an air supply unit;
adjusting a temperature set point of an air supply unit; and
adjusting operation of an equipment rack in the ventilated room.

25. A computer program configured to cause a computer to perform the method according to claim 1.

26. A computer system for estimating air flow within a ventilated room comprising a plurality of air supply units configured to supply air to a plurality of vents arranged across a floor of the room over an air supply plenum, the computer system configured to:
i) identify a vent having a minimum distance to any one of the air supply units;
ii) for each of a selected number of the air supply units, calculate a contribution of air flow supplied to the identified vent from a sum of ratios of distances between the identified vent and each of the air supply units; and
iii) repeat step ii) for a vent having a next minimum distance to any one of the air supply units until a contribution of air flow for each of the plurality of vents is calculated.

27. (canceled)

28. (canceled)
